(19) United States
(12) Patent Application Publication
(10) Pub. No.: US 2013/0279692 A1
(43) Pub. Date: Oct. 24, 2013

(54) PROTECTING MODULAR EXPONENTIATION IN CRYPTOGRAPHIC OPERATIONS

(71) Applicant: Regis Bevan, Paris (FR)

(72) Inventor: Regis Bevan, Paris (FR)

(73) Assignee: NAGRAVISION S.A., CHESEAUX-SUR-LAUSANNE (CH)

(21) Appl. No.: 13/824,599

(22) PCT Filed: Sep. 29, 2011
(86) PCT No.: PCT/EP2011/066952

§ 371 Date: Jul. 8, 2013

Related U.S. Application Data
(60) Provisional application No. 61/387,517, filed on Sep. 29, 2010.

(30) Foreign Application Priority Data
Oct. 4, 2010 (EP) 10290532.0

(51) Int. Cl. H04L 9/08

(52) U.S. Cl. CPC H04L 9/0816
USPC 380/46

(57) ABSTRACT

The present invention proposes a method for executing a blinded modular exponentiation, based on a window method with a window size of k bits so using 2^{k} pre-calculated variables (Yᵢ=Xⁱ mod N for i=0 to 2^{k}−1), on input data X of n bits to obtain output data S of n bits, S=X^{d} mod N, where d is the exponent of size m bits and N is the modulus of n bits, comprising the steps of: •blinding the pre-calculated variables by a blinding value Bi being a pseudo-random variable of the size of the modulus (n bits) and lower than the modulus (Yⱼ=Yᵢ×B₁ mod N for i=0 to 2^{k}−1) •executing the modular exponentiation with the blinded pre-calculated variables, to obtain an intermediate result (A), •unblinding the intermediate result by a unblinding value C₁=(B₁^{g})⁻¹ mod N where g equals the concatenation of m/k times the value “1” coded on k bits, to obtain the output data S.

### FIELD OF THE INVENTION

The invention relates to software and data cryptography. In particular, the invention relates to a method for hiding intermediate results of a modular exponentiation.

### INTRODUCTION

Till not so long ago, cryptography was concerned only by the protection of the communication of the message into a hostile environment. In classical scheme (a.k.a. black-box model), the attacker had only access to the inputs of the decryption device. With the emergence of Pay-TV, digital contents protected by DRM (movie, music in smart-phone, personal computer or in CD/DVD), attacker has now physically access to the decryption device and its outputs meaning that not only he can passively study the state and intermediate values of the encryption device, but also actively affect its computations.

Specifically, in 1996 appeared the notion of fault analysis: when submitting the decryption device to abnormal conditions (wrong input, abnormal temperature, strong electromagnetic radiations . . . ), the decryption algorithm can output faulty plaintext which gives information about the key used in the decryption device. See “On the Importance of Checking Cryptographic Protocols for Faults” of Dan Boneh, Richard A. DeMillo and Richard J. Lipton in the proceedings of Eurocrypt 1997.

In the same year appeared the notion of side-channel attacks: the physical signals (timing of processing, power consumption, electromagnetic radiations . . . ) that are output by the decryption device during the processing of the decryption can leak information (side-channel information) about the internal variables of the decryption algorithm. From this internal variables and statistic analysis, the attacker can retrieve information about the key used in the decryption device. See “Timing Attacks on Implementations of Diffie-Hellman, RSA, DSS, and Other Systems” of Paul C. Kocher in the proceedings of Crypto 1996.

Fault analysis and side-channel analysis belong to the grey-box model: the attacker has a limited knowledge about the implementation of the cryptographic algorithm and about its internal data. These attacks were successfully used to retrieve the keys and code source of smartcards used in pay-TV systems.

For music and movie on personal computer or on CD/DVD, the content keys are protected by obfuscation of software (DRM) because it is much less expensive than to distribute smartcards. In this case the environment is even more hostile than in the grey-box model, the attacker has a full access of the inner part of the software. This is what is called the white-box model. In 2002 appeared the concept of White-Box Cryptography. White-Box Cryptography is an obfuscation technique intended to implement cryptographic primitives in such a way, that even an adversary who has full access to the implementation and its execution platform, is unable to extract key information [1].

As described in the thesis of Brecht Wyseur about White-Box Cryptography, a countermeasure that is efficient against attacks in the white-box model is also efficient against attacks in the grey-box model.

### PRIOR ART

Modular exponentiation is involved in some important cryptographic protocols for key exchange or encryption or signature (Diffie-Hellman, ElGamal, RSA, DSS . . . ). It is well known in the art that the most basic method to perform a modular exponentiation is the so-called “square-and-multiply” algorithm [2] which consists in processing the exponent bit by bit and performing multiplication according to its value. In the following we review some of the notions relative to the notion of modular exponentiation as well as some of the state-of-the-art algorithms.
Exponentiation is a mathematical operation, written as b^{e}, involving two numbers, the base a and the exponent e. When e is a positive integer, exponentiation corresponds to repeated multiplication; in other words, a product of e factors of b: b×b . . . ×b
Modular exponentiation is a type of exponentiation performed over a modulus. Doing a “modular exponentiation” means calculating the remainder when dividing by a positive integer m (called the modulus) a positive integer b (called the base) raised to the e-th power (e is called the exponent). In other words, problems take the form where given base b, exponent e, and modulus m, one wishes to calculate c such that: c=b^{e} mod m
Basic binary modular exponentiation (square-and-multiply)

INPUT: an integer g of n bits and integer e of t+1 bits i.e. e=(eₜeₜ₋₁ . . . e₁e₀) where eᵢ is the i-th least significant bit of e, m the modulus of n bits.

OUTPUT: g^{e} mod m

1. A=1.

2. For i from t down to 0 do the following:
2.1 A=A×A mod m.
2.2 If eᵢ=1, then A=A×g mod m

3. Return(A)
The binary exponentiation can be substantially speed up by analysing the exponent by group of k bits. This method is also known as the window method, where the window size is k.
Modular exponentiation with window method

INPUT: g of n bits, e of (t+1)×b bits i.e e=(eₜeₜ₋₁ . . . e₁e₀)_{b}, where b=2^{k} for some k>1 and a modulus m of n bits

OUTPUT: g^{e} mod m

1. Precomputation.
1.1 G₀=1.
1.2 For i from 1 to (2^{k}−1) do: Gᵢ=Gᵢ₋₁×g. (Thus, Gᵢ=gⁱ.)

2. A=1.

3. For i from t down to 0 do the following:
3.1 B=A² mod m, A=B^{k} mod m
3.2 j=eᵢ, A=A×Gⱼ.

4. Return(A)

It should be emphasized that the goal of the attacker in any of the above models is to obtain the secret key in order to use it for its own illegal purposes. For modular exponentiation, if the exponent is properly protected by obfuscation techniques, the attacker will try to have information about the key by monitoring the intermediate results of the modular exponentiation. Those skilled in the art would notice in fact that in the case of the basic square-and-multiply method the secret key value (the exponent) can be trivially obtained by the attacker by simply observing the execution of the exponentiation algorithm and measuring the time (or the power consumed) of every step involved in the computation. The window method is also prone to some advanced side channel attack techniques such as Differential Power Analysis (DPA) described in [3].

Prior art for obfuscating cryptographic computations include a method proposed in [4]. The advantage of the present invention compared to the solution presented in [4] is that it requires no additional computations in the main loop except the “blinding” of the precomputed window factors hence performing the window-based exponentiation substantially faster.

While some number of other method for obfuscating and securing modular exponentiation operation were proposed in the prior art such as, for instance [5], they all do perform a masking (blinding) of the encrypted message itself (C) or the decryption exponent (d). Present invention proposes a new method where the masking is applied on the pre-calculated window values making it much more difficult to the attacker to bypass the blinding by one fault attack or software modification. Those skilled in the art understand that by “blinding” or “masking” the operation of randomization of a variable or a value is assumed such that the said variable or value frequently changes a hence cannot be identified and studied by an attacker using side channel attack methods.

### Problem to be Solved

The aim of the present invention is to provide a way to blind the intermediate results of the modular exponentiation in such a way that the blinding method is more difficult to bypass by advanced side channel analysis that the blinding method described in known art such as [4] and [5] as well as in “Timing Attacks on Implementations of Diffie-Hellman, RSA, DSS, and Other Systems” of Paul C. Kocher in the proceedings of Crypto 1996.

### BRIEF DESCRIPTION OF THE INVENTION

The present invention proposes a method for protecting modular exponentiation, based on a window method with a window size of k bits so using 2^{k} pre-calculated variables (Yᵢ=Xⁱ mod N for i=0 to 2^{k}−1), on input data X of n bits to obtain output data S of n bits, S=X^{d} mod N, where d is the exponent of size m bits and N is the modulus of n bits, comprising the steps of:
blinding the pre-calculated variables by a blinding value B₁ being a pseudo-random variable of the size of the modulus (n bits) and lower than the modulus (Yᵢ=Yᵢ×B₁ mod N for i=0 to 2^{k}−1)
executing the modular exponentiation with the blinded pre-calculated variables, to obtain an intermediate result (A),
unblinding the intermediate result by a unblinding value C₁=(B₁^{g})⁻¹ mod N where g equals the concatenation of m/k times the value “1” coded on k bits, to obtain the output data S.

### BRIEF DESCRIPTION OF THE FIGURE

The present invention will be better understood thanks to the attached FIGURE showing a processing unit able to execute the various steps of the claimed method.

### DETAILED DESCRIPTION OF THE INVENTION AND PREFERRED EMBODIMENT

The present invention describes a method for protection for a modular exponentiation operation using the so-called window method in an open software environment. By an open software environment we assume binary code which is executed on the said PC system and which can be accessed by an attacker.

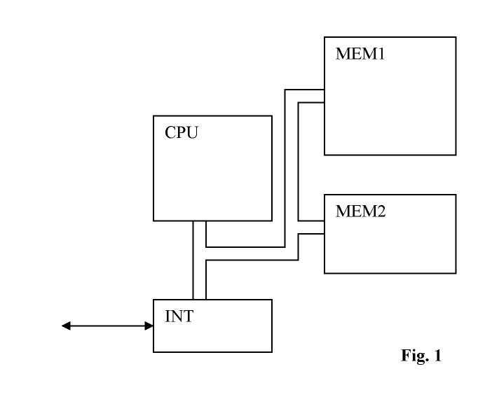

This invention can be implemented in a processing unit dedicated to execute cryptographic operations as illustrated in the FIG. 1. This unit comprises at least a processor CPU able to execute a software core and a memory MEM1 to store this code and provide the space necessary to store the temporary data MEM2. An interface INT is provided so as to receive the messages encrypted (or decrypted) to be stored in the temporary memory MEM2 for crypto processing. In the same manner, the interface INT can transmit the messages decrypted (or encrypted) to the other components of the reception device.

According to the preferred embodiment we consider a PC system or a processing unit which executes the said modular exponentiation operation using window method the said method implemented in the said software environment. Let X be the input data of n bits and K be the key which comprises an exponent d having m bits and a modulus N having n bits. The modular exponentiation operation implemented in the said PC system comprises two steps: pre-calculation and exponentiation. During the pre-calculation step values Yᵢ=Xⁱ mod N are pre-computed. Those skilled in the art notice that in the window method i varies between 0 to 2^{k}−1 and k represent the size of a window applied to the exponent d. During the exponentiation step the said pre-computed values Yᵢ are used.

Below the implementation of the invention is described in pseudocode. It is important to note that the steps described below are solely presented for the purpose of the preferred embodiment of the present invention and are not, in any case, limiting.

Use a register A of n bits, initialized with the value 1, for temporary storage of intermediate results of the exponentiation algorithm.

Use a register C of n bits, initialized with the value 1, for temporary storage of the last used random value,

Use a register v of log(m) bits, initialized with the value m/k
for j=m/k to 1, extracting k bits of the key d starting by the bit j×k,
   Determine a blinding condition (0/1) b based on a function f1 of j,
   If the blinding condition is set, execute:
      update a pseudorandom variable B of n bits
      for i=0 to 2^{k}−1, replacing the Yᵢ by Yᵢ×(B mod N),
      for i=0 to 2^{k}−1, replacing Yᵢ by Yᵢ×(C⁻¹ mod N),
      Replace A by A×C^{g} in which g is a function of (v−j) (i.e. g=−f2(v−j), where f2(r) is a number of k×r bits build from the concatenation of r times the number 1 coded on k bits e.g. if r=4 and k=2, then f2(r=4)=“01010101” in binary, f2(4)=0×55 in hexadecimal)
      Load the register C with the value of B,
      Load the register v with the value of j
   Replace the value A by (A^{K} mod N×Y_{dj} mod N), dj representing the j^{th} word of k bits of the exponent d when counting from the least significant bit to the most significant bit and K=2^{k}

The person skilled in the art would apprehend the advantage of this blinding method which consists in the fact that the blinding is involved in several computations (as many computations as the size of the windows), so it is more difficult for a side channel attacker to bypass the blinding by one fault attack or one software modification.

Another advantage with respect to the known prior art is the renewability of the blinding inside the algorithm which makes it more difficult to bypass the blinding for a fault attack or by means of software modifications.

The method according to claim 1, where the blinding value B₁ is renewed after the processing of several windows and the unblinding of the intermediate result is done by the multiplication by a variable C₁ which depends of the size of the window (k), the number of windows which were processed (w), the modulus N and the initial blinding value B₁: C₁=(B₁^{h})⁻¹ mod N where h equals the concatenation of w times the value “1” coded on k bits.

Another advantage is that a hacker can not find a specific function T such that submitting T(X) as input of the modular exponentiation will make the intermediate results stored in A independent of the blinding variable B, even if B is a known constant.

The overhead of the countermeasure if the unblinding steps are not pre-computed, compared to the classical exponentiation algorithm, is an exponentiation with the same length than the input exponent d and as many inversions as the number of blinding updates.

According to another particular embodiment, when implemented on the said PC system the claimed method can be simplified when constraints on speed exist by blinding the pre-calculated variables once at the very beginning of the exponentiation algorithm and then removing the blinding at the end of the exponentiation. The overhead of the countermeasure is then one exponentiation with the same length than the input exponent d and only one inversion.

Those skilled in the art know that the modular exponentiation method is usually used in the context of RSA cryptosystem. According to a particular embodiment, when the modular exponentiation algorithm is used for RSA computation with a private key d (which might be relatively large in size in terms of bits), the claimed method can be speed up according to the followings steps:
pre-computing e′=g⁻¹ mod (p−1)×(q−1) where g equals the concatenation of m/k times the value “1” coded on k bits.
blinding of the pre-calculated variables (Yᵢ=Xⁱ mod N) by a same blinding value B₂ such that B₂=B₁^{e′} mod N, B₁ being a pseudo-random variable of the size of the modulus and lower than the modulus (Yᵢ=Yᵢ×B₂ mod N for i=0 to 2^{k}−1)
executing the modular exponentiation with the blinded pre-calculated variables, to obtain an intermediate result (A),
unblinding of the intermediate result by the inverse of B₁

By this way, the blinding overhead is reduced to one exponentiation with a small exponent (exponentiation by e′) and one inversion.

According to the preferred embodiment the pseudorandom variable B can be renewed by different methods. Furthermore values of B used between two executions of the main method can also be different. Below such implementations are described in accordance with the preferred embodiment.

One way of speed up is to create a link between the new and the previous blinding. In the case of the blinding value B is renewed after the processing of w windows, the blinding values used during the exponentiation is an array of sub-blocks B=(B₁, B₂, B₃, . . . Bₙ), the subsequent sub-block Bᵢ₊₁ being the square value modulo N of the preceding Bᵢ, each sub-block Bᵢ being a pseudo-random variable of the size of the modulus and lower than the modulus, the unblinding values used during the exponentiation is an array of sub-blocks C=(C₁, C₂, C₃ . . . Cₙ) the subsequent sub-block Cᵢ₊₁ being the square value of the preceding Cᵢ, Cᵢ=(Bᵢ^{g})⁻¹ mod N where g equals the concatenation of w times the value “1” coded on k bits but only C₁ is computed using the inversion, the other Cᵢ being the square of the preceding.

B can be updated inside the main algorithm but the same values for B can be used between two executions of the main method: the different values of B and of C^{g} can thus be pre-computed to remove the overhead of the exponentiation and of the inversions.

In a particular case of the preferred embodiment, the method comprises a step of pre-computing and storing the value C^{g} where the blinding value B is a digest of all or part of the modular exponentiation code.

### REFERENCES

[1] “White-Box Cryptography and an AES Implementation” of Stanley Chow, Philip A. Eisen, Harold Johnson, and Paul C. van Oorschot in the proceedings of the 9th International Workshop on Selected Areas in Cryptography (SAC 2002)
[2] “Handbook of applied cryptography” of A. Menezes, P. van Oorshot and S. Vanstone.
[3] “Differential Power Analysis”, Paul Kocher, Joshua Jaffe and Benjamin Jun in the proceedings of Advances in Cryptology—CRYPTO '99, 19th Annual International Cryptology Conference
[4] “Method of obscuring cryptographic computations”, Ernie F. Brickel, Pub. No US 2005/0084098
[5] “Cryptographic method comprising a modular exponentiation secured against hidden-channel attacks, cryptoprocessor for implementing the method and associated chip card”, Mathieu Ciet, Benoit Feix, Pub No. 2007/074149

1. A method for protecting modular exponentiation in cryptographic operations executed by a processing unit, said modular exponentiations being based on a window method with a window size of k bits, using 2^{k} pre-calculated variables (Yᵢ=Xⁱ mod N for i=0 to 2^{k}−1), on input data X of n bits to obtain output data S of n bits, S=X^{d} mod N, where d is the exponent of size m bits and N is the modulus of n bits, comprising the steps of:
blinding the pre-calculated variables by a blinding value B₁ being a pseudo-random variable of the size of the modulus (n bits) and lower than the modulus (Yᵢ=Yᵢ×B₁ mod N for i=0 to 2^{k}−1)
executing the modular exponentiation according to the window method which is based on the division of the exponent d into blocks of size of at most k bits representing a window, with the said blinded pre-calculated variables to obtain an intermediate result (A),
unblinding the intermediate result by a unblinding value C₁=(B₁^{g})⁻¹ mod N where g equals the concatenation of m/k times the value “1” coded on k bits, to obtain the output data S.

2. The method according to claim 1, where the window method is based on the division of the exponent d into blocks of at most k bits representing a window, and the blinding value B₁ is renewed after the processing of one or more said blocks and the unblinding of the intermediate result is done by the multiplication by a variable C₁ which depends of the size of the window (k), the number of windows which were processed (w), the modulus N and the initial blinding value B₁: C₁=(B₁^{h})⁻¹ mod N where h equals the concatenation of w times the value “1” coded on k bits.

3. The method according to claim 1, where the modulus N is the product of two primes p, q of n/2 bits, comprising the steps of:
pre-computing e′=g⁻¹ mod (p−1)×(q−1) where g equals the concatenation of m/k times the value “1” coded on k bits.
blinding of the pre-calculated variables (Yᵢ=Xⁱ mod N) by a same blinding value B₂ such that B₂=B₁^{e′} mod N, B₁ being a pseudo-random variable of the size of the modulus and lower than the modulus (Yᵢ=Yᵢ×B₂ mod N for i=0 to 2^{k}−1)
executing the modular exponentiation with the blinded pre-calculated variables, to obtain an intermediate result (A),
unblinding of the intermediate result by the inverse of B₂

4. The method according to claim 1, where the blinding value B₁ is a dynamic random value which is updated at each execution of the steps of the modular exponentiation with the blinded pre-calculated variables.

5. The method according to claim 2, where the blinding value is renewed after each processing of window of k bits, the blinding values used during the exponentiation is an array of sub-blocks B=(B₁, B₂, B₃, . . . Bₙ), the subsequent sub-block Bᵢ₊₁ being the square value modulo N of the preceding Bᵢ, each sub-block Bᵢ being a pseudo-random variable of the size of the modulus and lower than the modulus, the unblinding values used during the exponentiation is an array of sub-blocks C=(C₁, C₂, C₃ . . . Cₙ) the subsequent sub-block Cᵢ₊₁ being the square value of the preceding Cᵢ, Cᵢ=(Bᵢ^{h})⁻¹ mod N where h equals the concatenation of w times the value “1” coded on k bits but only C₁ is computed using the inversion, the other Cᵢ being the square of the preceding.

6. The method according to claim 1, where the blinding value B₁ is a static pseudorandom value and the unblinding value is pre-computed according to this static value once for multiple execution of the method of claim 1.

7. The method according to claim 1, comprising the step of precomputing and storing the value C₁ where the blinding value B₁ is a digest of all or part of the modular exponentiation code.

8. The method according to claim 2, where the blinding value B₁ is a dynamic random value which is updated at each execution of the steps of the modular exponentiation with the blinded pre-calculated variables.

9. The method according to claim 3, where the blinding value B₁ is a dynamic random value which is updated at each execution of the steps of the modular exponentiation with the blinded pre-calculated variables.

10. The method according to claim 3, where the blinding value B₁ is a static pseudorandom value and the unblinding value is pre-computed according to this static value once for multiple execution of the method of claim 3.

11. The method according to claim 5, where the blinding value B₁ is a static pseudorandom value and the unblinding value is pre-computed according to this static value once for multiple execution of the method of claim 5.
